(19) United States
(12) Patent Application Publication
(10) Pub. No.: US 2007/0126723 A1
(43) Pub. Date: Jun. 7, 2007

(54) Liquid crystal display having improved image and modifying method of image signal thereof

(76) Inventor: Sunkwang Hong, Seongnam-si (KR)

Correspondence Address: MACPHERSON KWOK CHEN & HEID LLP, 2033 GATEWAY PLACE, SUITE 400, SAN JOSE, CA, 95110, US

(21) Appl. No.: 11/633,759

(22) Filed: Dec. 4, 2006

(30) Foreign Application Priority Data
Dec. 5, 2005 (KR) 10-2005-0117583

(51) Int. Cl. G09G 5/00

(52) U.S. Cl. 345/204

(57) ABSTRACT

A liquid crystal display includes a plurality of pixels; an image signal modifier comparing a previous image signal and a current image signal, modifying the current image signal based on the comparison result to generate a first modified image signal, calculating an average modified value, and modifying the first modified image signal into a second modified image signal based on the average modified value; and a data driver supplying a data voltage corresponding to the second modified image signal to the pixel.

### CROSS-REFERENCE TO RELATED APPLICATION

This application claims priority to and the benefit of Korean Patent Application No. 10-2005-0117583 filed in the Korean Intellectual Property Office on Dec. 5, 2005, the contents of which are incorporated herein by reference.

### FIELD OF THE INVENTION

The present invention relates to a liquid crystal display and a modifying method of the image signals thereof.

### DESCRIPTION OF THE RELATED ART

Liquid crystal displays (LCDs) include a pair of panels provided with field generating electrodes and a liquid crystal (LC) layer having dielectric anisotropy disposed between the two panels. The field generating electrodes generally include a common electrode and a plurality of pixel electrodes arranged in a matrix that are connected to switching elements such as thin film transistors (TFTs) supplied with data voltages. A pair of field generating electrodes and the liquid crystal layer form a liquid crystal capacitor. The strength of the electric field determines the orientation of the liquid crystal molecules which determine the transmittance of light passing through the liquid crystal layer to obtain the desired images. In order to prevent image deterioration due to long-term application of a unidirectional electric field, the polarity of the voltages is reversed every frame, every row, or pixel.

When the LCD is used for displaying moving images the time required to charge the liquid crystal capacitances and orient the LC molecules may cause blurring of the images which is proportional to the speed of the moving image.

### SUMMARY OF THE INVENTION

According to an embodiment of the present invention, a liquid crystal display compares previous and current image signals, calculates an average modified value with respect to reference pixels in a reference frame and supplies data voltages to the pixels based on the current, previous and average modified reference image signals

The image signal modification may calculate average differences between current image signals and a first modified image signal with respect to the reference pixels to define an average modified value. The image signal modification may select one of a plurality of weight regions in which the average modified value is included. The weight regions may be defined by classifying a range of the average modified value based on the speed and a complexity of the moving image.

The image signal modifier may include a frame memory outputting the previous image signal and storing the current image signal, a lookup table yielding a reference modified image signal with respect to the current image signal and the previous image signal, generating a first modified image signal based on the reference modified image signal from the lookup table, calculating the average modified value for the reference pixels in the reference frame, and modifying the first modified image signal into a second modified image signal based on the average modified value.

According to an embodiment of the present invention, the current image signal and a previous image signal are compared and the current image signal is modified to generate a first modified image signal, an average of modified values is calculated with respect to reference pixels as an average modified values in a reference frame, one of a plurality of weight regions is selected in which the average modified value is included, and a second modified image signal is obtained based on the weight value corresponding to the selected region.

The average modified value calculation may include calculating differences between current image signals and a first modified image signal with respect to the reference pixels, and calculating an average of the differences to define as the average modified value. The average modified value calculation may include calculating the average modified value by a unit frame group or a unit time. The reference frame may be a first frame of the unit frame group or a first frame after the unit time is started. The second modified image signal output may include multiplying the weight value by the first modified image signal to generate the second modified image signal.

### BRIEF DESCRIPTION OF THE DRAWING

The foregoing objects, features and advantages of the present invention will become more apparent from a reading of the ensuing description together with the accompanying drawing, in which:

FIG. 1 is a block diagram of an LCD according to an exemplary embodiment of the present invention;

FIG. 2 is an equivalent circuit diagram of a pixel of an LCD according to an exemplary embodiment of the present invention;

FIG. 3A to FIG. 3C are examples of images for calculating average values according to moving speeds, respectively;

FIG. 4 is a graph of average modifying values with respect to respective moving speeds of the images shown in FIGS. 3A to 3C; and

FIG. 5 is a block diagram of an image signal modifier of an LCD according to an exemplary embodiment of the present invention.

### DETAILED DESCRIPTION OF THE EMBODIMENTS

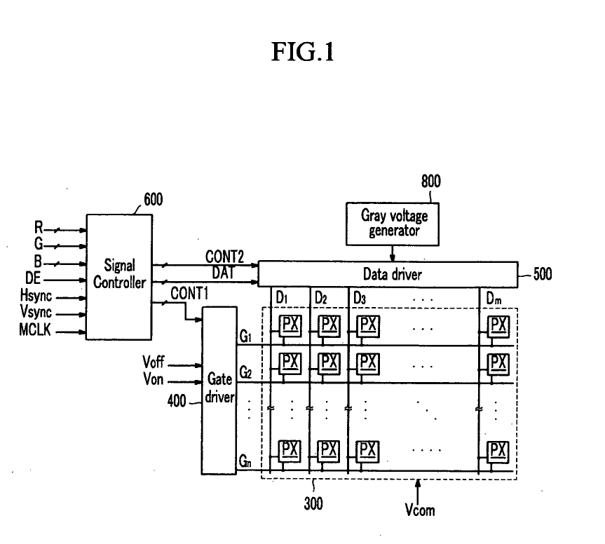

FIG. 1 is a block diagram of an LCD according to an exemplary embodiment of the present invention showing a liquid crystal (LC) panel assembly 300, a gate driver 400 and a data driver 500, a gray voltage generator 800, and a signal controller 600 controlling the above elements.

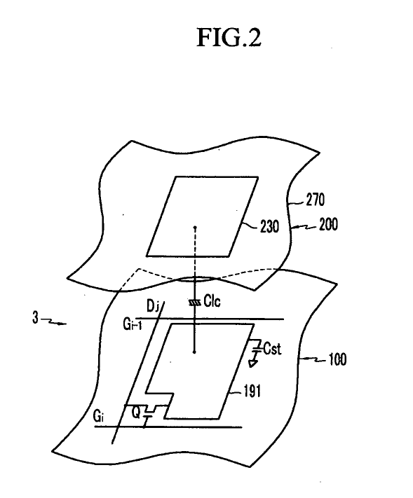

Panel assembly 300 includes a plurality of signal lines G₁ -Gₙ and D₁-Dₘ and a plurality of pixels PX connected to the signal lines G₁-Gₙ and D₁-Dₘ and arranged substantially in a matrix. In the structural view shown in FIG. 2, panel assembly 300 includes lower and upper panels 100 and 200 facing each other, and an LC layer 3 interposed between panels 100 and 200.

The signal lines include a plurality of gate lines G₁-Gₙ transmitting gate signals (also referred to as “scanning signals” hereinafter) and a plurality of data lines D₁-Dₘ transmitting data voltages. The gate lines G₁-Gₙ extend substantially in a row direction and substantially parallel to each other, while the data lines D₁-Dₘ extend substantially in a column direction and substantially parallel to each other.

Referring to FIG. 2, each pixel PX, for example a pixel PX connected to the i-th gate line Gᵢ (i=1, 2, . . . , n) and the j-th data line Dⱼ (j=1, 2, . . . , m), includes a switching element Q connected to the signal lines Gᵢ and Dⱼ, and an LC capacitor Clc and a storage capacitor Cst that are connected to the switching element Q. The storage capacitor Cst may be omitted.

Switching element Q disposed on the lower panel 100 has three terminals, i.e., a control terminal connected to the gate line Gᵢ, an input terminal connected to the data line Dⱼ, and an output terminal connected to the LC capacitor Clc and the storage capacitor Cst.

The LC capacitor Clc includes a pixel electrode 191 disposed on lower panel 100 and a common electrode 270 disposed on upper panel 200 as two terminals. LC layer 3 disposed between the two electrodes 191 and 270 functions as the dielectric of the LC capacitor Clc. Pixel electrode 191 is connected to switching element Q. Common electrode 270 is supplied with a common voltage Vcom and covers the entire surface of the upper panel 200. Unlike FIG. 2, common electrode 270 may be provided on the lower panel 100, and at least one of the electrodes 191 and 270 may have the shape of a bar or a stripe.

Storage capacitor Cst is an auxiliary capacitor for the LC capacitor Clc that includes pixel electrode 191 and a separate signal line provided on lower panel 100 that overlaps and is insulated from pixel electrode 191 and is supplied with a predetermined voltage such as the common voltage Vcom. Alternatively, storage capacitor Cst may include pixel electrode 191 and an adjacent gate line called a previous gate line which overlaps and is insulated from pixel electrode 191.

For color display, each pixel may uniquely represent one of primary colors (i.e., spatial division) or each pixel may sequentially represent the primary colors in turn (i.e., temporal division) such that the spatial or temporal sum of the primary colors is recognized as a desired color. An example of a set of the primary colors includes red, green, and blue colors. FIG. 2 shows an example of the spatial division in which each pixel includes a color filter 230 representing one of the primary colors in an area of the upper panel 200 facing the pixel electrode 191. Alternatively, color filter 230 may be provided on or under the pixel electrode 191 on lower panel 100. One or more polarizers (not shown) are attached to the panel assembly 300.

Referring to FIG. 1 again, gray voltage generator 800 may generate a full complement of gray voltages or a limited number of gray voltages (referred to as “reference gray voltages” hereinafter) that are related to the transmittance of the pixels PX. Some of the (reference) gray voltages have a positive polarity relative to the common voltage Vcom, while the other of the (reference) gray voltages have a negative polarity relative to the common voltage Vcom.

Gate driver 400 is connected to gate lines G₁-Gₙ and synthesizes a gate-on voltage Von and a gate-off voltage Voff to generate the gate signals for application to the gate lines G₁-Gₙ.

Data driver 500 is connected to data lines D₁-Dₘ and applies data voltages selected from the gray voltages supplied from the gray voltage generator 800. However, when gray voltage generator 800 generates only a few of the reference gray voltages rather than all the gray voltages, data driver 500 may divide the reference gray voltages to generate the data voltages.

Each of driving devices 400, 500, 600, and 800 may include at least one integrated circuit (IC) chip mounted on the LC panel assembly 300 or on a flexible printed circuit (FPC) film in a tape carrier package (TCP) type, which are attached to the panel assembly 300. Alternatively, at least one of the driving devices 400, 500, 600, and 800 may be integrated into the panel assembly 300 along with the signal lines G₁-Gₙ and D₁-Dₘ and the switching elements Q, or all the driving devices 400, 500, 600, and 800 may be integrated into a single IC chip, but at least one of the driving devices 400, 500, 600 and 800 or at least one circuit element in at least one of the processing units devices 400, 500, 600, and 800 may be disposed out of the single IC chip.

Now, the operation of the above-described LCD will be described in detail.

Signal controller 600 is supplied with input image signals R, G, and B and input control signals from an external graphics controller (not shown). The input image signals R, G, and B contain luminance information for pixels PX. The luminance has a predetermined number of grays, for example, 1024 (=2¹⁰), 256(=2⁸), or 64 (=2⁶) grays. The input control signals include a vertical synchronization signal Vsync, a horizontal synchronization signal Hsync, a main clock signal MCLK, and a data enable signal DE.

On the basis of the input control signals and the input image signals R, G, and B, signal controller 600 generates gate control signals CONT1 and data control signals CONT2 and processes the image signals R, G, and B to be suitable for the operation of the panel assembly 300 and the data driver 500. Signal controller 600 sends the gate control signals CONT1 to gate driver 400 and sends the processed image signals DAT and the data control signals CONT2 to data driver 500.

The gate control signals CONT1 include a scanning start signal STV for instructing to start scanning and at least one clock signal for controlling the output period of the gate-on voltage Von. The scanning control signals CONT1 may include an output enable signal OE for defining the duration of the gate-on voltage Von.

The data control signals CONT2 include a horizontal synchronization start signal STH for starting data transmission for a row of pixels PX, a load signal LOAD for the application of the data voltages to data lines D₁-Dₘ, and a data clock signal HCLK. The data control signal CONT2 may further include an inversion signal RVS for reversing the polarity of the data voltages (relative to the common voltage Vcom).

Responsive to the data control signals CONT2 from the signal controller 600, data driver 500 receives a packet of the digital image signals DAT for the row of pixels PX from the signal controller 600, converts the digital image signals DAT into analog data voltages selected from the gray voltages, and applies the analog data voltages to the data lines D₁-Dₘ.

Gate driver 400 applies the gate-on voltage Von to a gate line G₁-Gₙ in response to the scanning control signals CONT1 from the signal controller 600 thereby turning on switching transistors Q. The data voltages applied to the data lines D₁-Dₘ are then supplied to the pixels PX through the activated switching transistors Q.

The difference between a data voltage applied to a pixel PX and the common voltage Vcom is the voltage across the LC capacitor Clc, referred to as the pixel voltage. The orientation of the LC molecules in the LC capacitor Clc depend on the magnitude of the pixel voltage, and the molecular orientations determine the polarization and transmittance of light passing through LC layer 3. The pixel PX has a luminance represented by the gray value of the data voltage.

By repeating this procedure for each horizontal period (also referred to as “1H”, i.e., one period of the horizontal synchronization signal Hsync and the data enable signal DE), all gate lines G₁-Gₙ are sequentially supplied with the gate-on voltage Von for a frame.

When the next frame starts after one frame finishes, the inversion signal RVS applied to the data driver 500 is controlled such that the polarity of the data voltages is reversed (which is referred to as “frame inversion”). The inversion signal RVS may also be controlled such that the polarity of the data voltages flowing in a data line are periodically reversed during one frame (for example row inversion and dot inversion), or the polarity of the data voltages in one packet are reversed (for example column inversion and dot inversion).

The voltage across the LC capacitor C_{LC} forces the LC molecules in the LC layer 3 to be reoriented into a stable state corresponding to the voltage. The reorientation of the LC molecules takes a certain amount of time since the response time of the LC molecules is slow. So long as the voltage across the LC capacitor is maintained, the LC molecules continue to reorient themselves to vary the light transmittance until they reach a stable state. When the LC molecules reach the stable state and stop the reorientation, the light transmittance becomes steady. The pixel voltage when the LC molecules reach a stable state is referred to as the target pixel voltage and the light transmittance in the stable state is referred to as target light transmittance.

Because only a limited time is available for turning on the switching element Q of each pixel PX to apply a data voltage, it is difficult for the LC molecules to reach the stable state. However, even though the switching element Q is turned off, the voltage across the LC capacitor C_{LC} still exits and thus the LC molecules continue the reorientation such that the capacitance of the LC capacitor C_{LC} changes. Ignoring leakage current, the total amount of electrical charges stored in the LC capacitor C_{LC} is kept constant when the switching element Q turns off since one terminal of the LC capacitor C_{LC} is floating. Therefore, the variation of the capacitance of the LC capacitor C_{LC} results in the variation of the voltage across the LC capacitor C_{LC}, i.e., the pixel voltage.

When a pixel PX is supplied with a data voltage corresponding to a target pixel voltage (referred to as a “target data voltage” hereinafter), the actual voltage of the pixel PX may be different from the target pixel voltage and consequently the pixel PX may not reach the target light transmittance. The actual pixel voltage differs from the target pixel voltage in proportion to the difference between the initial and target light transmittance.

Accordingly, the data voltage applied to the pixel PX is required to be higher or lower than the target data voltage. This can be realized by using DCC (dynamic capacitance compensation).

According to an embodiment of the present invention, DCC, which may be performed by signal controller 600 or by a separate image signal modifier, modifies the current image signal g_{N} for a pixel to generate a “first modified image signal” g_{N}′ based on the image signal of a preceding frame (referred to hereinafter as the “previous image signal”) g_{N-1}. The first modified image signal g_{N}′ is basically obtained by experiments, and the difference between the first modified current image signal g_{N}′ and the previous image signal g_{N-1}′ is usually larger than the difference between the current image signal g_{N} before modification and the previous image signal g_{N-1}′. However, when the current image signal g_{N}′ and the previous image signal g_{N-1}′ are equal to each other or the difference therebetween is small, the first modified image signal g_{N}′ may be equal to the current image signal g_{N} (that is, the current image signal may not be modified).

The first modified image signal g_{N}′ may be represented as a function F1 of Equation 1.
g_{N}′=F(g_{N},g_{N-1}) [Equation 1]

Accordingly, the data voltage applied from the data driver 500 to each pixel PX may be larger or smaller than the target data voltage.

TABLE 1 shows exemplary modified image signals for some pairs of previous image signals g_{N-1} and current image signals g_{N} in a 256 gray system.

This image signal modification requires a storage unit such as a frame memory for storing the previous image signals g_{N-1}. In addition, a lookup table is required for storing a relationship that may be as that shown in TABLE 1.

TABLE 1

| | g_{N-1} | | | | | | | | | | | | | | | | | |
|---|---|---|---|---|---|---|---|---|---|---|---|---|---|---|---|---|---|---|
| | | 0 | 16 | 32 | 48 | 64 | 80 | 96 | 112 | 128 | 144 | 160 | 176 | 192 | 208 | 224 | 240 | 255 |
| g_{N} | 0 | 0 | 0 | 0 | 0 | 0 | 0 | 0 | 0 | 0 | 0 | 0 | 0 | 0 | 0 | 0 | 0 | 0 |
| | 16 | 30 | 16 | 9 | 7 | 6 | 3 | 3 | 3 | 2 | 2 | 2 | 1 | 0 | 0 | 0 | 0 | 0 |
| | 32 | 77 | 52 | 32 | 21 | 18 | 15 | 13 | 12 | 11 | 10 | 10 | 8 | 7 | 6 | 4 | 4 | 3 |
| | 48 | 120 | 90 | 70 | 48 | 36 | 30 | 23 | 20 | 17 | 15 | 15 | 14 | 13 | 12 | 11 | 9 | 7 |
| | 64 | 145 | 120 | 95 | 76 | 64 | 55 | 47 | 41 | 34 | 30 | 27 | 25 | 23 | 21 | 18 | 15 | 12 |
| | 80 | 165 | 138 | 121 | 100 | 90 | 80 | 70 | 64 | 58 | 53 | 50 | 46 | 41 | 36 | 30 | 24 | 19 |
| | 96 | 179 | 154 | 136 | 122 | 114 | 104 | 96 | 88 | 83 | 78 | 73 | 69 | 63 | 55 | 48 | 41 | 34 |
| | 112 | 187 | 166 | 152 | 141 | 133 | 127 | 119 | 112 | 104 | 98 | 92 | 86 | 82 | 76 | 68 | 61 | 54 |
| | 128 | 196 | 177 | 164 | 157 | 150 | 144 | 138 | 133 | 128 | 120 | 113 | 107 | 101 | 95 | 88 | 81 | 74 |
| | 144 | 203 | 189 | 177 | 171 | 166 | 162 | 157 | 153 | 149 | 144 | 137 | 132 | 125 | 119 | 113 | 106 | 99 |
| | 160 | 211 | 200 | 189 | 184 | 182 | 178 | 175 | 172 | 168 | 164 | 160 | 155 | 149 | 143 | 137 | 131 | 125 |
| | 176 | 218 | 209 | 201 | 198 | 196 | 194 | 191 | 188 | 185 | 182 | 179 | 176 | 170 | 165 | 160 | 154 | 149 |
| | 192 | 226 | 221 | 215 | 212 | 211 | 209 | 207 | 204 | 202 | 199 | 197 | 195 | 192 | 187 | 183 | 178 | 175 |
| | 208 | 236 | 233 | 226 | 225 | 224 | 224 | 222 | 220 | 219 | 217 | 215 | 213 | 211 | 208 | 205 | 201 | 198 |
| | 224 | 244 | 243 | 240 | 237 | 237 | 237 | 236 | 235 | 234 | 232 | 231 | 229 | 227 | 226 | 224 | 222 | 220 |
| | 240 | 255 | 255 | 254 | 254 | 253 | 253 | 251 | 250 | 248 | 246 | 245 | 254 | 253 | 242 | 241 | 240 | 240 |
| | 255 | 255 | 255 | 255 | 255 | 255 | 255 | 255 | 255 | 255 | 255 | 255 | 255 | 255 | 255 | 255 | 255 | 255 |

Since the size of a lookup table for containing the first modified image signals g_{N}′ for all pairs of current and previous image signals g_{N-1} and g_{N} may be tremendous, it is preferable that TABLE 1 only store reference modified signals. Accordingly, the first modified image signals g_{N}′ for other pairs of previous and current image signals g_{N-1} and g_{N} are obtained by interpolation. The interpolation process finds in TABLE 1 the pairs of previous and current image signals g_{N-1} and g_{N} that are closest to the current signal pair.

For example, each digital image signal is divided into MSBs (most significant bits) and LSBs (least significant bits), and the lookup table stores reference modified signals for the pairs of previous and current image signals g_{N-1} and g_{N} having zero LSBs. For a pair of previous and current image signals g_{N-1} and g_{N}, some reference modified image signals associated with MSBs of the signal pair are found, and a first modified image signal g_{N}′ for the signal pair is calculated from LSBs of the signal pair and the reference modified image signals found from the lookup table.

The modification of the image signals and the data voltages may or may not be performed for the highest or lowest gray value. In order to modify the highest gray or the lowest gray, the range of gray voltages generated by gray voltage generator 800 may be widened as compared with the range of target data voltages required for obtaining the range of the target luminance (or the target transmittance) represented by the grays of the image signals.

However, since the amount of blurring that is due to the slow response speed of the liquid crystals varies in accordance with the speed and complexity of the moving images, the first modified image signal g_{N}′ is modified based on the moving speed and complexity to generate a second modified image signal g_{N}″.

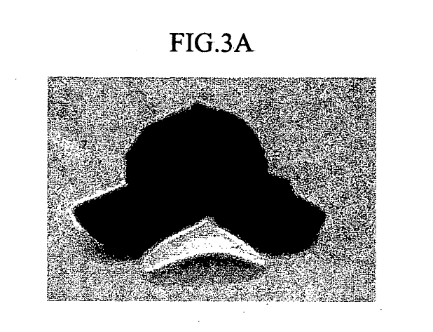

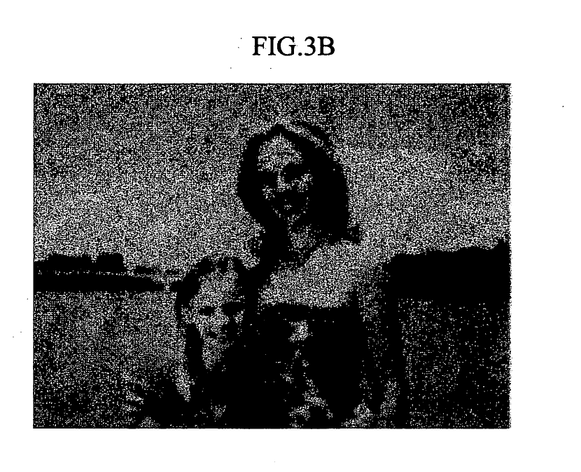

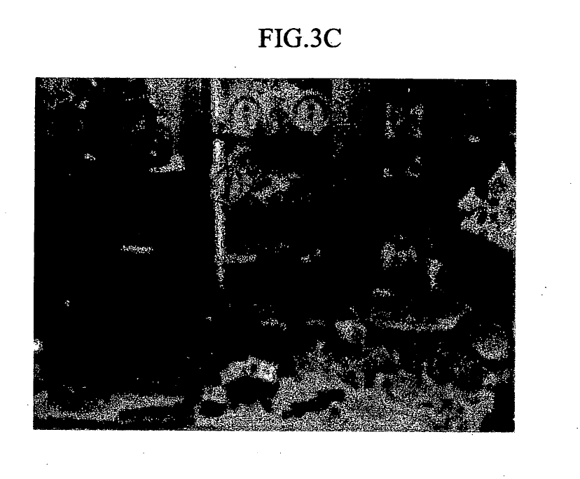

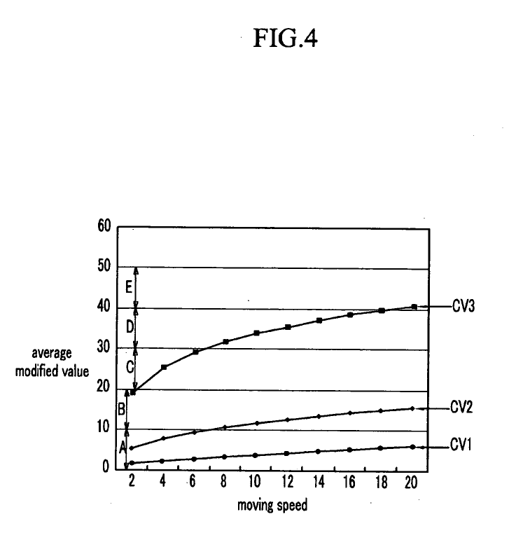

Referring to FIGS. 3A to 4, the difference between the current image signal g_{N} and the first modified image signal g_{N}′ in accordance with the moving speed and the complexity of the moving images will be described.

FIG. 3A to FIG. 3C are examples of images for calculating average values according to moving speeds, respectively, and FIG. 4 is a graph of average modifying values with respect to respective moving speeds of the images shown in FIGS. 3A to 3C.

Curves CV1-CV3 shown in FIG. 4 respectively indicate averages (referred to as “average modified values” hereinafter) of the modified values with respect to predetermined pixels (referred to as “reference pixels” hereinafter) after obtaining the first modified image signals g_{N}′ using the DCC based on the reference modified image signals of TABLE 1, while varying the moving speeds of respective images shown in FIGS. 3A to 3B

At this time, the reference pixels may be all pixels or pixels within a predetermined row and column distance in any one frame (referred to as “reference frame”) respectively. In addition, the reference pixels may be pixels corresponding to the reference modified image signals.

As shown in curve CV1 of FIG. 4, when the complexity of an image is low, as shown in FIG. 3A, the variation of the average modified value per increment of moving speed is not large, and the magnitude of the average modified value is also not large. As shown in curve CV3, when the complexity of an image is large, as shown in FIG. 3C, the variation of the average modified value per increment of moving speed is large, and the magnitude of the average modified value is also large.

In accordance with an aspect of the present embodiment, the DCC operation is modified according to the speed and complexity of the moving image. When the average modified value with respect to the reference pixels is large, the speed of the displayed image is fast or the image is complex. Thus, the complexity or the moving speed of the image displayed on a screen may be determined using the average modified value.

In an exemplary embodiment, after obtaining the variation of the average modified value according to the moving speed and the complexity of an image based on experimental results, as shown in FIG. 4, the ranges of the average modified value are classified into a plurality of weight regions, for example first to fifth weight regions (A-F in FIG. 4). Then, different weight values are given to respective weight regions, and the second modified image signal g_{N}″ is generated by multiplying the weight value corresponding to each region by the first modified image signal g_{N}′. The weight value that is varied based on the weight region is defined by experimental results, etc. The operation for determining the corresponding weight region of the current image that is displayed is performed for a predetermined number of frames (a unit frame group), for example ten frames, or for a predetermined time (a unit time), for example one second, but may be performed every frame.

For example, as shown in FIG. 4, when the average modified value of the reference pixels, which is obtained in the reference frame, is 0≦average modified value<10, an image in the reference frame is classified as the first weight region A, and when the average modified value is 10≦average modified value<20, the image of the reference frame is classified as the second weight region B. In addition, when the average modified value is 20≦average modified value<30 an image of the reference frame is classified as the third weight region C, when the average modified value is 30≦average modified value<40 the image of the reference frame is classified as the fourth weight region D, and when the average modified value is 40≦average modified value<50 the image of the reference frame is classified as the fifth weight region E. The weight value for the first weight region A is denoted as α1, the second weight value for the second weight region B is denoted as α2, the weight value for the third weight region C is denoted as α3, the weight value for the fourth weight region D is denoted as α4, and the weight value for the fifth weight region E is denoted as α5. The number of classified weight regions may be varied in accordance with the region of the average modified value, etc., and the magnitude of the weight values are different from each other. It is preferable that as the magnitude of the average modified value become larger, that is, the moving speed or the complexity comes to increase, the magnitude of the weight value becomes large.

In an embodiment of the present, the reference frame may be a first frame of the unit frame group or a first frame after a unit time is started.

After selecting the corresponding weight region based on the average modified value, a weight value α1-α5 corresponding to the selected weight region from the next frame is multiplied by the first modified image signal g_{N}′ to generate the second modified image signal g_{N}″.

Since the first modified image signal g_{N}′ calculated by DCC is adjusted using the weight value that varies according to the complexity and the moving speed of an image, the blurring phenomenon which is proportional to the complexity and the moving speed of the image is reduced.

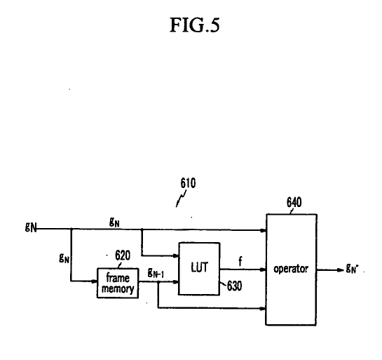

Next, an image signal modifier of an LCD according to an exemplary embodiment of the present invention for modifying the image signals will be described with reference to FIG. 5.

FIG. 5 is a block diagram of an image signal modifier of an LCD according to an exemplary embodiment of the present invention.

Referring to FIG. 5, an image signal modifier 610 according to an exemplary embodiment of the present invention includes a frame memory 620 connected to a current image signal g_{N}, a lookup table 630 connected to the current image signal g_{N} and the frame memory 620, and an operator 640 connected to them. The image signal modifier 610 or at least one thereof may be included in the signal controller 600 shown in FIG. 1, or may implemented in a separate device.

Frame memory 620 supplies a stored previous image signals g_{N-1} to lookup table (LUT) 630 and operator 640 and stores the current image signal g_{N}. Fame memory 620 stores image signals displayed in the LCD as a frame unit, and may be located outside of image signal modifier 610.

Lookup table 630 may be configured, for example, as a 17×17, etc., matrix as show in Table 1. Rows and columns represent the previous image signals g_{N-1} and the current image signals g_{N}, respectively. Reference modified image signals f with respect to image signals g_{N-1} and g_{N} are stored at the intersection of the row and columns. Lookup table 630 is supplied with the previous image signal g_{N-1} and the current image signal g_{N} and outputs the corresponding reference modified image signal f to operator 640.

Operator 640 generates the first modified image signal g_{N}′ using interpolation based on the reference modified image signal f from the lookup table 630, the previous image signal g_{N-1} and the current image signal g_{N}, obtains a corresponding weight value based on an average modified value of the reference pixels calculated by the unit frame group or the unit time, and modifies the first modified image signal g_{N}′ into the second modified image signal g_{N}″ for output.

That is, in the first frame of the unit frame group or the first frame after the unit time is started, the operator 640 generates the first modified image signals g_{N}′ corresponding to the current image signals g_{N} for all pixels, and output them to the data driver 500. The operator 640 also calculates an average, that is, an average modified value of modified values that are differences between the current image signals g_{N} and the first modified image signals g_{N}′ with respect to the reference pixels.

Then, the operator 640 determines in which of the weight regions A-E the average modified value is included, and selects a corresponding weight value with respect to the determined weight region. The range of the average modified values for the respective weight regions A-E and the weight values for the respective weight regions are already stored in a memory (not shown), etc. of the operator 640. After generation of the first modified image signal g_{N}′ to all pixels, the operator 640 calculates the average modified value. In an alternative embodiment, the operator 640 may calculate the average modified value by operating the modified values of the reference pixels while generating the first modified image signal g_{N}′.

Next, from a second frame, the operator 640 multiplies the selected weight value by the first modified image signal image signal g_{N}′ with respect to the current image signal (g_{N}) of each of pixels to generate the second modified image signal g_{N}″ and output it to the data driver 500.

When a first frame of the next unit frame group starts, or a new unit time starts by elapse of the unit time, the operator 640 calculates first modified image signals g_{N}′ with respect to all pixels to output to the data driver 500, calculates an average modified value with respect to the reference pixels, and determines a weight region corresponding to the average modified value. Thereby, from a second frame, the operator 640 multiplies a weight value corresponding to the determined weight region by the first modified image signals g_{N}′ to generate the second modified image signals g_{N}″ and output them to the data driver 500, respectively.

In an exemplary embodiment, without calculation of the second modified image signals g_{N}″ in the first frame of each unit frame group or in the first frame after the unit time starts, the first modified image signals g_{N}′ are outputted as the second modified image signals g_{N}″. Alternatively, the second modified image signals g_{N}″ from the first frame may be calculated to output to the data driver 500. In this case, the first modified image signals g_{N}′ may be temporary stored in a buffer, etc., and then the second modified image signals g_{N}″ may be calculated by multiplying the respective selected weight values by the respective first modified image signals g_{N}′ and be sequentially outputted.

According to the present invention, in DCC, final modified image signals are calculated by multiplying weight values that are varied based on the moving speed or the complexity of a displayed image to the modified image signals calculated by operation of the DCC. Thereby, a blurring phenomenon that is influenced by the moving speed or the complexity is reduced, to improve image quality.

While this invention has been described in connection with what is presently considered to be practical exemplary embodiments, it is to be understood that various modifications and equivalent arrangements will be apparent to those skilled in the art and may be made without, however, departing from the spirit and scope of the invention.

What is claimed is:

1. A liquid crystal display comprising:
a plurality of pixels;
an image signal modifier comparing a previous image signal and a current image signal, modifying the current image signal based on the comparison result to generate a first modified image signal, calculating an average modified value, and modifying the first modified image signal into a second modified image signal based on the average modified value; and
a data driver supplying a data voltage corresponding to the second modified image signal to the pixel.

2. The liquid crystal display of claim 1, wherein the image signal modifier calculates differences between current image signals and first modified image signals with respect to reference pixels, and calculates an average of the differences to define the average modified value.

3. The liquid crystal display of claim 2, wherein the image signal modifier calculates the average modified value with respect to the reference pixels in a reference frame, selects one of a plurality of weight regions in which the average modified value is included, and modifies the first modified image signal into the second modified image signal using a weight value corresponding to the selected weight region.

4. The liquid crystal display of claim 3, wherein the image signal modifier multiplies the weight value by the first modified image signal to generate the second modified image signal.

5. The liquid crystal display of claim 4, wherein the image signal modifier calculates the average modified value by a unit frame group or a unit time.

6. The liquid crystal display of claim 5, wherein the reference frame is a first frame of the unit frame group or a first frame after the unit time is started.

7. The liquid crystal display of claim 6, wherein the image signal modifier modifies the first modified image signal into the second modified image signal using the weight value corresponding to the selected weight region from a second frame of the unit frame group or a second frame after the unit time is started.

8. The liquid crystal display of claim 3, wherein the weight regions are defined by classifying a range of the average modified value based on a moving speed and a complexity of an image.

9. The liquid crystal display of claim 3, wherein the magnitude of the weight value is increased as the average modified value increases.

10. The liquid crystal display of claim 1, wherein the image signal modifier comprises:
a frame memory outputting the previous image signal and storing the current image signal;
a lookup table outputting a reference modified image signal with respect to the current image signal and the previous image signal from the frame memory; and
an operator generating the first modified image signal based on the reference modified image signal from the lookup table, calculating the average modified value for reference pixels in the reference frame, and modifying the first modified image signal into the second modified image signal based on the average modified value.

11. The liquid crystal display of claim 10, wherein the reference modified image signal corresponds to the first modified image signal with respect to the reference pixel.

12. A modifying method of image signals of a liquid crystal display including a plurality of pixels, the method comprising:
reading a current image signal and a previous image signal of a pixel;
comparing the previous image signal and the current image signal, and modifying the current image signal based on the comparison result to generate a first modified image signal;
calculating an average of modified values with respect to reference pixels as an average modified value in a reference frame;
selecting one of a plurality of weight regions, in which the average modified value is included; and
modifying the first modified image signal into a second modified image signal based on the weight value corresponding to the selected region.

13. The method of claim 12, wherein the average modified value calculation comprises calculating differences between current image signals and first modified image signals with respect to the reference pixels, and calculating an average of the differences to define as the average modified value.

14. The method of claim 12, wherein the average modified value calculation comprises calculating the average modified value by a unit frame group or a unit time.

15. The method of claim 14, wherein the reference frame is a first frame of the unit frame group or a first frame after the unit time is started.

16. The method of claim 12, wherein the second modified image signal output comprises multiplying the weight value by the first modified image signal to generate the second modified image signal.

17. A method of operating a liquid crystal display, comprising:
comparing pixel values of previous and current frames of image signals;
calculating average values for pairs of pixels in the current and previous frames; and
supplying data voltages to the pixels of the display based on the current, previous, and the calculated average values of the pixels in the image signal.
